(19) United States
(12) Patent Application Publication
(10) Pub. No.: US 2002/0095103 A1
(43) Pub. Date: Jul. 18, 2002

(54) Portable, vibrating relaxation device

(76) Inventor: Ulett S. Blue, Roselle, NJ (US)

Correspondence Address: Law Offices of, John D. Gugliotta, P.E., Esq., 202 Delaware Building, 137 South Main Street, Akron, OH, 44308, US

(21) Appl. No.: 09/760,400

(22) Filed: Jan. 12, 2001

(51) Int. Cl. A61H 1/00

(52) U.S. Cl. 601/46

(57) ABSTRACT

A portable, vibrating relaxation device is provided powered by batteries and controlled by a timer. The use of the portable, vibrating relaxation device allows parents and care givers the ability to soothe and comfort an infant while attending to other matters.

### RELATED APPLICATIONS

The present invention was first described in Disclosure Document No. 480,414 filed on Sep. 28, 2000. There are no previously filed, nor currently any co-pending applications, anywhere in the world.

### BACKGROUND OF THE INVENTION

1. Field of the Invention

The present invention relates generally to infant relaxation devices and, more particularly, to a portable, vibrating relaxation device.

2. Description of the Related Art

While caring for a newborn baby can be one of the most rewarding duties a person may bear, it is often one of the most traumatizing. This is due to the fact that people know so very little about newborns due to the amount of time they are exposed to them. Every action or lack of action is questioned as to whether or not it is the correct thing for the infant to be doing at that stage of development. One action that occupies a great deal of time on the part of parents or care givers is the patting or rubbing of the infant to aid in putting the infant to sleep or simply to soothe the infant to prevent crying. While the time spent doing this is an important part of the infant's development and bonding with the parent or care giver, there are times when the necessary comfort cannot be provided due to other commitments or activities that must be performed.

Accordingly, there is a need for a means by which a rubbing or patting sensation can be provided for an infant in a manner which does not require the presence of a parent or care giver. The development of the portable, vibrating relaxation device fulfills this need.

A search of the prior art did not disclose any patents that read directly on the claims of the instant invention; however, the following references were considered related. The following patents disclose a baby calming device using mother's heartbeat sound: U.S. Pat. No. 6,004,259 issued in the name of Sedaros; U.S. Pat. No. 5,063,912 issued in the name of Hughes; and U.S. Pat. No. 3,994,282 issued in the name of Moulet.

U.S. Pat. No. 5,205,811 issued in the name of Fornarelli describes a baby blanket with a heartbeat vibrator.

U.S. Pat. No. 4,947,832 issued in the name of Blitzer discloses an apparatus for simulating a mother's womb conditions to treat or relieve colicky infants.

U.S. Pat. No. 4,941,453 issued in the name of Shakas et al. describes a hammock for a baby with sensors to simulate a human heartbeat.

U.S. Pat. No. 4,124,022 issued in the name of Gross discloses a heart-shaped relaxation device with a heartbeat simulator.

U.S. Pat. No. 3,292,611 issued in the name of Belkin describes an infant mattress with devices equipped to pacify the infant.

Consequently, a need has been felt for providing a device which allows parents and care givers the ability to soothe and comfort an infant while attending to other matters.

### SUMMARY OF THE INVENTION

Therefore, it is an object of the present invention to provide a vibrating mechanism which adds vibrating capabilities to infant care devices.

It is another object of the present invention to provide a vibrating mechanism which aids in soothing infants and putting them to sleep.

It is another object of the present invention to provide a vibrating mechanism which can be used on infant seats, car seats, strollers, cribs, and the like.

It is another object of the present invention to provide a vibrating mechanism of which an adult-sized version is also envisioned.

It is another object of the present invention to provide a vibrating mechanism which is controlled by an on/off switch.

It is another object of the present invention to provide a vibrating mechanism controlled by a timer which prevents over discharge of batteries.

It is another object of the present invention to provide a fastening mechanism such as hook and loop fasteners for easily attaching and removing the device to almost any object.

It is another object of the present invention to be powered by a rechargeable battery thus allowing the device to be used anywhere.

It is another object of the present invention to be powered by alkaline batteries or rechargeable batteries which can be easily replaced by the user.

It is another object of the present invention to eliminate a care giver's worries by allowing the care giver to attend other duties while stimulation is applied to the infant.

It is another object of the present invention to provide a lightweight, durable, and sanitary device.

Briefly described according to one embodiment of the present invention, a portable, vibrating relaxation device is a portable vibrating mechanism powered by batteries and controlled by a timer. The invention takes the form of a small pad with an internal vibrating mechanism such as a vibration generator. The vibrating mechanism is powered by a set of rechargeable batteries, but alkaline batteries could also be utilized. The operation of the vibrating mechanism is controlled by an on/off switch with the backup of a timer to deactivate the power after a predetermined period of time to prevent over discharge of the batteries. The invention is secured by straps with hook and loop fasteners such as Velcro®, or by suction cups to strollers, car seats, infant carriers and the like. It is envisioned that a larger version of the invention could be used on chairs, beds or sofas for use by adults. The use of the portable, vibrating relaxation device allows parents and care givers the ability to soothe and comfort an infant while attending to other matters.

### BRIEF DESCRIPTION OF THE DRAWINGS

The advantages and features of the present invention will become better understood with reference to the following more detailed description and claims taken in conjunction with the accompanying drawings, in which like elements are identified with like symbols, and in which:

FIG. 1 is a perspective view of a portable, vibrating relaxation device according to the preferred embodiment of the present invention;

FIG. 2 is a bottom plan view of the removable cover according to the preferred embodiment of the present invention;

FIG. 3 is a cross-sectional view taken along lines III-III of FIG. 1, according to the preferred embodiment of the present invention;

FIG. 4 is a side elevational view of the main housing according to the preferred embodiment of the present;

FIG. 5 is a bottom plan view thereof;

FIG. 6 is a side elevational view of the vibration generator according to the preferred embodiment of the present invention;

FIG. 7 is a schematic diagram of the electronic circuitry according to the preferred embodiment of the present invention;

FIG. 8 is a perspective view of the present invention according to the preferred embodiment shown attached to a crib; and

FIG. 9 is a side elevational view of the remote control.

### DESCRIPTION OF THE PREFERRED EMBODIMENT

1. Detailed Description of the Figures

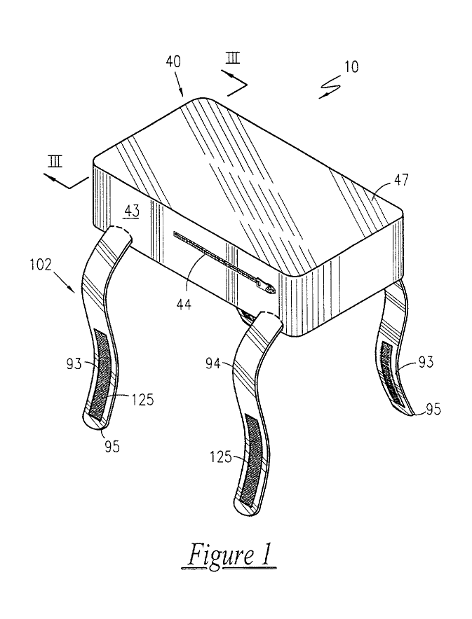

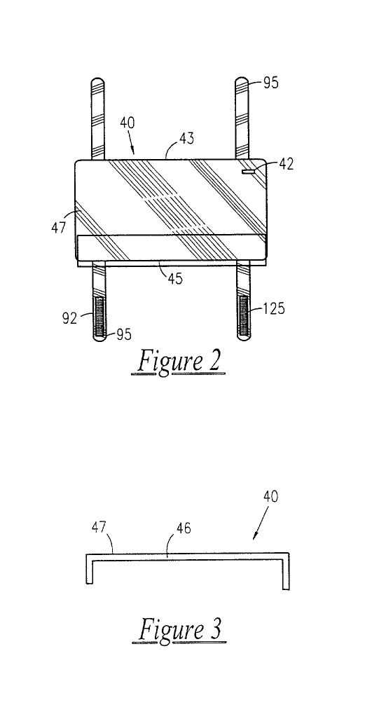

Referring now to FIGS. 1-9, a portable, vibrating relaxation device 10 is shown, according to the present invention, comprised of a main housing 20, a vibration generator 30, a removable cover 40, and an integrated circuit timer 60. The present invention provides comfort to an infant via a portable vibrating device actuated by flipping an on/off switch 50 located on a bottom side 21 of the main housing 20.

The removable cover 40 is fabricated of a washable, textile material such as cotton, linen, nylon, or polyester. A rectangular void 42 is formed in the removable cover 40 for allowing the on/off switch 50 to extend therethrough, thus providing access thereof by a user. A zipper 44 is included which extends linearly along a front sidewall 43 of the removable cover 40. The zipper 44 is of a length accommodating removal of the removable cover 40 from the main housing 20.

The removable cover 40 further includes a soft inner layer 46 of spongy, compressible material so as to provide a soft, pliant, and pleasing feel when the removable cover 40 is grasped. The inner layer 46 also provides shock protection for internal components in the event the device is dropped.

It is envisioned that the removable cover 40 would have an outer surface 47 available in various colors and in various aesthetic designs incorporated thereon.

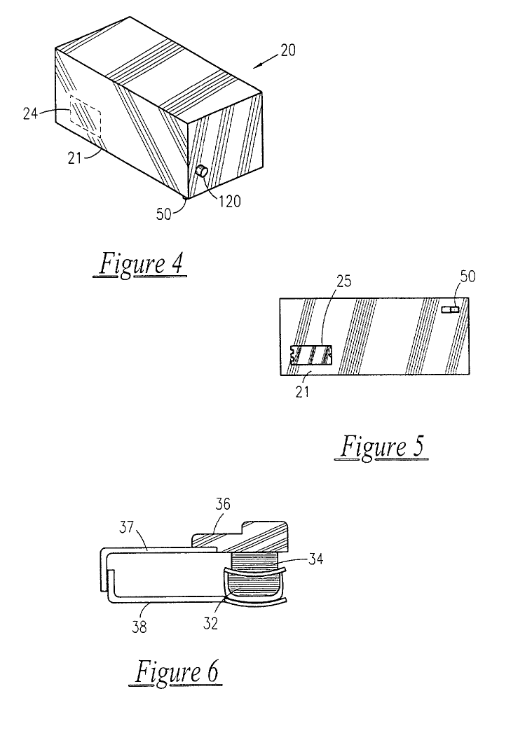

Referring now in greater detail to FIGS. 4 and 5, the main housing 20 is molded of a rectangular, hollow configuration fabricated preferably of a rigid plastic material capable of injection molding, and therefore can be formed easily of recycled material. The housing 20 is designed to contain internal components of the present invention including a rechargeable battery 48, the integrated circuit timer 60, and a circuit board 70 which bears major electrical circuitry of the vibration generator 30.

A battery compartment 24 is provided within the main housing 20, and is located on the bottom side 21 thereof, opposite the on/off switch 50.

A compartment door 25, which is snapped to an opened and closed position, is hinged to the bottom side 21 of the main housing 20 so as to provide access to the battery 48 in the event the battery 48 needs to be replaced.

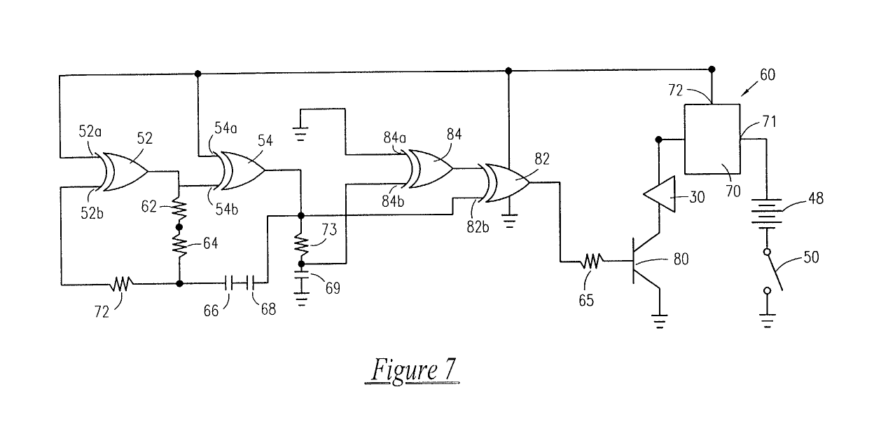

Referring now in greater detail to FIGS. 6 and 7, the vibration generator 30 is attached to an internal sidewall of the main housing 20 by a suitable attachment means such as by screws or adhesive. The vibration generator 30 includes a coil 32 wrapped around a magnetizable armature 34 and a to magnetizable plate 36. The plate 36 is mounted to an upper panel 37 and a base 38, and is slightly spaced from a face of the armature 34. The vibration generator 30 is coupled between a transistor 80 and the circuit board 70.

Electrical circuitry includes the circuit timer 60 connected thereto which has a duty cycle for maintaining a time constant. In accordance with the present invention, the electrical circuitry is designed and configured such that a wave signal is produced having a very rapid repetition rate as is typically produced in vibrating pagers and vibrating toothbrushes, and the wave signal will maintain a time constant of approximately 20 minutes. Upon completion of the time constant, current ceases to flow through the electrical circuitry, thus actuating inoperability of the vibration generator 30.

FIG. 7 sets forth a schematic diagram of the internal components which function as described henceforth. A positive potential of battery 48 is applied, via switch 50, through input 71 of circuit board 70 and exits therefrom through output 72 to a first of two inputs 52a, 54b of each exclusive OR gates 52, 54, respectively. Being at a lower voltage, a second input 52b of gate 52 causes gate 52 to produce a positive output which is applied to a second input 54b of gate 54, thus causing gate 54 to produce zero output. The positive output from gate 52 is applied to resistors 62, 64 aligned in series, and the positive output continues through the resistor 62, 64 to charge capacitors 66, 68 which are connected in series. An increasing charge to capacitors 66, 68 supplies sufficient positive voltage to the second input 52b of gate 52 coupled thereto through resistor 72, thus causing gate 52 to produce zero output, and in turn causing gate 54 to produce a positive output. The positive output of gate 54 is applied through resistor 73 to charge capacitor 69 and is also applied to a second input 82b of gate 82. A second input 84b of gate 84 is coupled to resistor 73 and capacitor 69, which are aligned in parallel combination, and the second input 84b of gate 84 receives sufficient positive voltage to produce a positive output. A first input 84a of gate 84 is grounded. Upon an output of gate 84 going positive, gate 82 ceases producing positive output. An output of gate 82 is applied through resistor 65 to transistor 80 which causes the transistor 80 to conduct current from the battery 48 through the coil 32 of the vibration generator 30 and to ground.

The purpose of the aforementioned electrical circuit serves to produce a series of very rapid pulses, thereby providing soothing vibration for aiding in putting infants to sleep. As shown in conjunction with FIG. 7, a series of rapid pulses are generated. When this series of pulses are applied to the coil 32 of the vibration generator 30 for magnetizing the armature 34 thereby attracting the plate 36, then releasing the plate 36 (as best shown in conjunction with FIG. 6).

Characteristics of the vibration generator 30 and electrical circuitry are appropriately inter-related so as to actuate extremely rapid movement of the plate 36, thereby providing a vibrating device which vibrates similarly to a frequency of vibrations exhibited by vibrating pagers and vibrating toothbrushes.

Referring now to FIGS. 1, 2, and 8, in order to removably attach the 10 to an upper horizontal rail member 90 of a crib 100, an attachment means 102 is provided which includes a plurality of linearly elongated straps 92 sewn to a lower portion of the front sidewall 43 and a lower portion of a rear sidewall 45 of the removable cover 40. Each strap 92 is defined as having a top side 93 opposite a bottom side 94. The straps 92 sewn to the lower portion of the front sidewall 43 have an elongated rectangular layer of Velcro® material 125 sewn at a free end 95 to a top side 93 thereof, and the flaps 92 sewn to the lower portion of the rear sidewall 45 have an elongated, rectangular layer of Velcro® material 125 sewn at a free end 95 to a bottom side 94 thereof. A bottom side of the device is placed horizontally on an external surface of the horizontal rail member 90 of the crib 100, and each free end 95 of the flaps 92 which are sewn to the front sidewall 43 is wrapped around each free end 95 of the flaps 92 which are sewn to the rear sidewall 45 in an overlapping manner around the rail member 90 of the crib 100, such that the layers of Velcro® material 125 come into connective contact with one another, thereby removably securing the device around the rail member 90 of a crib 100. The attachment means 102 disclosed is meant only as a suggestion and is in no way limiting. It is envisioned that other suitable attachment means such as snap-on, clamps, and suction cups could be utilized.

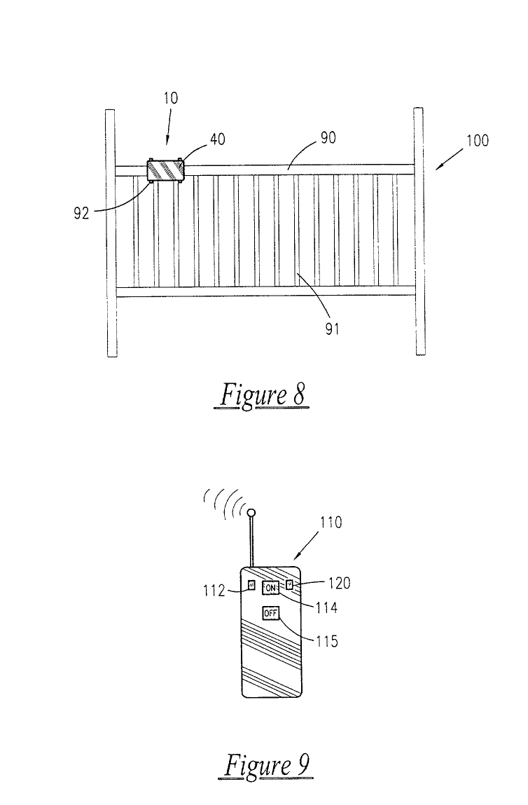

The linearly elongated design of the straps 92 coupled with the elongated layers of Velcro® material 125 sewn to ends 95 thereof, provide a removably attachable device for accommodating chairs, sofas, car seats, strollers, and other similar places for occupying infants. As shown in FIG. 8, the present invention is attached in a horizontal position; however, it is envisioned that the device could not only be attached in a vertical position to a vertical rail member 91 of a crib 100, but could also be attached in a variety of other positions via the straps 92.

It is envisioned that the present invention can be actuated via remote control 110 shown in FIG. 9. The remote control 110 would comprise a timer-over ride button 112 which would allow a user to prematurely stop operation of the vibration generator 30 before the 20 minute time constant expires.

Depressing an ON button 114 would provide for continued operation of the device beyond the 20 minute time constant for an indefinite period of time as desired by the user.

Depressing an OFF button 115 would turn the device in an off position until reactivated by pressing the ON button 114 located on a face of the remote control 110, or by flipping the on/off switch 50 on the main housing 20.

It is further envisioned that an accelerated vibration button 120 would be provided with the remote control 110 and the main housing 20. Depressing the accelerated vibration button 120 would cause the vibration generator 30 to vibrate with an increased frequency. A subsequent depression of the accelerated vibration button 120 would actuate the vibration generator 30 to operate at original vibrational pulses, thus providing a vibration generator 30 having two modes, namely, a normal mode and a high mode.

The required electrical circuitry for accommodating and providing for the operability of the remote control 110, the timer-over ride button 112, the ON button 114, the OFF button 115, and the accelerated vibration button 120 is logic technology widely known by those skilled in the art.

It is envisioned that a larger version of the present invention could be removably attached to chairs, beds or sofas for use by adults.

2. Operation of the Preferred Embodiment

To use the present invention, the user wraps each free end 95 of the flaps 92 which are sewn to the front sidewall 43 of the removable cover 40 around each free end 95 of the flaps 92 which are sewn to the rear sidewall 45 of the removable cover 40 in an overlapping manner around the rail member 90 of the crib 100, such that the layers of Velcro® material 125 come into connective contact with one another, thereby removably securing the device around the rail member 90 of a crib 100. Next, the user flips the on/off switch 50 in order to actuate the vibration generator 30 to vibrate for a period of approximately 20 minutes. In the event the user desires to prematurely stop operation of the vibration generator 30 before the 20 minute time constant expires, the user depresses the timer-over ride button 112 button located on a face of the remote control 110. The user depresses the ON button 114 of the remote control 110 for continued operation of the device beyond the 20 minute time constant for an indefinite period of time as desired. The user depresses the OFF button 115 to turn the device in an off position until reactivated by pressing the ON button 114 located on a face of the remote control 110, or by flipping the on/off switch 50 on the main housing 20.

In the event the user desires the device 10 to vibrate with increased vibrational pulses, he simply depresses the accelerated vibration button 120 located on the face of the remote control 110. A subsequent depression of the accelerated vibration button 120 by the user actuates the vibration generator 30 to operate at original vibrational pulses.

The use of the portable, vibrating relaxation device allows parents and care givers the ability to soothe and comfort an infant while attending to other matters.

Therefore, the foregoing description is included to illustrate the operation of the preferred embodiment and is not meant to limit the scope of the invention. As one can envision, an individual skilled in the relevant art, in conjunction with the present teachings, would be capable of incorporating many minor modifications that are anticipated within this disclosure. Therefore, the scope of the invention is to be broadly limited only by the following claims.

What is claimed is:

1. A portable, vibrating relaxation device comprising:
a main housing;
a vibration generator retained within said main housing and attached to an internal sidewall of said main housing;
a removable cover fabricated of a washable, textile material forming a rectangular void for receiving said main housing; and
an integrated circuit timer for regulating the control of said vibration generator.

2. The portable, vibrating relaxation device of claim 1, wherein said removable cover further includes a soft inner layer of spongy, compressible material so as to provide a soft, pliant, and pleasing feel when the removable cover is grasped.

3. The portable, vibrating relaxation device of claim 2, wherein said removable cover further comprises an aesthetic outer surface.

4. The portable, vibrating relaxation device of claim 1, wherein said vibration generator includes a coil wrapped around a magnetizable armature and a magnetizable plate, said plate mounted to an upper panel and a base and is slightly spaced from a face of the armature.

5. The portable, vibrating relaxation device of claim 2, further comprising an attachment means for attaching to an upper rail member of an otherwise conventional crib.

6. The portable, vibrating relaxation device of claim 5, wherein said attachment means includes a plurality of linearly elongated straps sewn to a lower portion of a front sidewall and a lower portion of a rear sidewall of said removable cover.
